(19) United States
(12) Patent Application Publication
(10) Pub. No.: US 2008/0178750 A1
(43) Pub. Date: Jul. 31, 2008

(54) METHOD AND APPARATUS FOR CUTTING THE TOP OFF AN IMMATURE COCONUT

(76) Inventors: Gary J. Rogers, Lehi, UT (US); Carol R. Winder, Pittsburgh, PA (US)

Correspondence Address: Angus C. Fox, III, 4093 N. Imperial Way, Provo, UT, 84604-5386, US

(21) Appl. No.: 12/020,512

(22) Filed: Jan. 25, 2008

Related U.S. Application Data
(60) Provisional application No. 60/886,512, filed on Jan. 25, 2007.

(51) Int. Cl. A23N 15/00; B26D 7/02; B26D 1/01; B26D 1/00

(52) U.S. Cl. 99/537; 83/452; 83/694; 83/859

(57) ABSTRACT

An apparatus for removing the top of an immature coconut safely, quickly and easily with little spillage of the internal liquid includes an enclosure in which are housed a pair of opposed blades that are coupled by at least one rotatable shaft having both left-hand and right-hand threads. Opposite ends of each shaft engage a threaded sleeve affixed to each blade. When axially rotated in a first direction, the blades are brought together so that they cut in a common plane. When rotated in the opposite direction, the blades retract. A clamping mechanism secures the immature coconut at an optimum elevation, with its central axis generally vertical, so that the top of the fruit can be removed just below the upper limit of the hollow interior space, thereby minimizing liquid loss. A vertically-compressible coil spring, placed below the clamping mechanism, facilitates removal of the opened coconut.

### PRIORITY DATA

This application has a claim of priority based on the filing of provisional patent application No. 60/886,512 of the same title and by the same inventors on Jan. 25, 2007.

### BACKGROUND OF THE INVENTION

1. Field of the Invention

This invention relates, generally, to cutting methods and cutting apparatus and, more particularly, to methods and apparatus for safely cutting the top off a fruit, such as a young coconut, which has a tough, but not hard or brittle, endocarp.

2. Description of the Prior Art

The coconut palm is a member of the Arecaceae, or palm, family, the coconut palm is a large palm with pinnate leaves 4 to 6 meters long and pinnae 60 to 90 cm long that grows to heights of 30 meters. It has the distinction of belonging to both an exclusive genus (Cocos) and an exclusive species (nucifera). The name nucifera is Latin for nut-bearing. Old leaves break away cleanly from the trunk of a coconut palm, leaving it smooth. The term coconut refers to the fruit of the coconut palm.

The origins of this plant are uncertain, with some authorities claiming it is native to south-east Asia, while others claim its origin is in north-western South America. Regardless of its origin, the coconut has spread across much of the tropics, probably aided in many cases by sea-faring peoples. The fruit is light and buoyant and presumably spread significant distances by marine currents: fruits collected from the sea as far north as Norway have been found to be viable (subsequently germinated under the right conditions). In the Hawaiian Islands, the coconut is believed to have been first brought to the Islands by early Polynesian voyagers from their homelands in the South Pacific.

The coconut palm thrives on sandy soils and is highly tolerant of salinity. It prefers areas with abundant sunlight and regular rainfall (750 to 2,000 mm annually), which makes colonizing shorelines of the tropics relatively straightforward. Coconuts also need high humidity (70-80%+) for optimum growth, which is why they are rarely seen in areas such as the Mediterranean, which have low humidity-even where temperatures are high enough (regularly above 24° C.). They are very hard to establish in dry climates, as they would require frequent irrigation. In addition, through they may grow in areas, such as Bermuda, where there is not sufficient warmth, they will not fruit properly. Coconut palms are also intolerant of freezing weather. They will show leaf injury below 34° F. (1° C.), defoliate at 30° F. (−1° C.) and die at 27° (−3° C.). One night of freezing weather can set the growth of a coconut palm back about 6 months. The only two states in the U.S. where coconut palms can be grown and reproduce outdoors without irrigation are Hawaii and Florida. While coconut palms flourish in south Florida, unusually bitter cold snaps can kill or injure coconut palms there as well. Only the Florida Keys provide a safe haven from the cold as far as growing coconut palms on the U.S. mainland. Suffice it to say that in regions of the planet between 26°N and 26°S of the equator, which have adequate humidity and no freezing weather, coconut palms are ubiquitous.

The flowers of the coconut palm are polygamomonoecious, with both male and female flowers in the same inflorescence. Flowering occurs continuously, with female flowers producing seeds. Coconut palms are believed to be largely cross-pollinated, although some dwarf varieties are self-pollinating.

Botanically, a coconut is not a true nut, but rather a simple dry fruit known as a fibrous drupe. The husk, or mesocarp, is composed of fibers called coir and there is an inner “stone,” or endocarp. Coconuts are typically sold in non-tropical countries with the mesocarp removed and the hard endocarp exposed. The endocarp has three germination pores that are clearly visible on the surface of the endocarp once the husk is removed. It is through one of these pores that the radicle emerges when the embryo germinates. The configuration of the three pores also give the coconut its name. An end view of the endocarp and germination pores gives to the fruit the appearance of a coco, a Portuguese word for a scary witch from Portuguese folklore, that used to be represented as a carved vegetable lantern, hence the name of the fruit. Adhered to the inside wall of the endocarp is the testa, or hard outer seed covering, which surrounds a thick albuminous endosperm—the white and fleshy edible part of the seed known as the coconut “meat”. The endosperm surrounds a hollow interior space, filled with air and often a liquid referred to as coconut water. Coconut water from the unripe coconuts is commonly drunk fresh as a refreshing drink. Coconut milk (not to be confused with the coconut water, is made by grating the endocarp and mixing it with warm water. The resulting thick, white liquid called coconut milk, is used in much Asian cooking (e.g., in curries).

When the coconut is still green, the endosperm inside is thin and tender, and makes a tasty snack. However, coconuts are usually picked when green in order to drink the coconut water. A large coconut can contain up to one liter of refreshing drink. When the coconut has ripened in a couple of months, the outer husk will have turned brown, the coir will have become dryer and softer, and it will fall from the palm of its own accord. At that time the endosperm has thickened and hardened, while the coconut water has become somewhat bitter.

Opening a coconut takes a certain degree of acquired skill. The outer husk must first be removed if the coconut has not been husked prior to sale. In order to drain the water, two of the three eyes of the fruit are pierced (one to allow the coconut water to escape; the other to allow air to enter). It is interesting to note that “coconut water” has excellent isotonic electrolyte balance, and contains sugars, fibre, proteins, anti-oxidants, vitamins and minerals. For that reason, it is used as a refreshing drink throughout the humid tropics. The isotonic electrolyte balance also makes coconut water useful as an intravenous fluid, as coconut water is sterile until the coconut is opened. Mature fruits have significantly less liquid than young immature coconuts. As coconuts have a naturally-formed, visible fracture line, they can be opened by taking a heavy knife, such as a meat cleaver, and striking the coconut on the fracture line with the flat edge of the knife. Alternatively, one may employ a flat-bladed screwdriver and a hammer (which is easier, and may be safer than using a cleaver). Once the screwdriver has been driven slightly into the shell at the fracture line, the shell can be cracked by twisting the screwdriver. The coconut should then be turned, and the process repeated until there is a contiguous crack in the shell around the entire fruit. Afterwards, the fruit can be cleaved about this crack.

There is growing demand for young, or immature, coconuts, in non-tropical countries, on account of their tender, thin endosperm and sweet coconut water. Normally sold with the husk, or mesocarp, removed, immature coconuts do not have a brittle endocarp. Instead, the endocarp is fibrous and spongy. Hence, immature coconuts are not candidates for the standard coconut cracking process detailed above. FIGS. 1, 2 and 3 show a husked immature coconut 100. The husked immature coconut 100, which looks somewhat like a miniature cylindrical water tank, has a conical top 101, a lower portion 102 that is typically a slightly-tapered, right conical section which is almost cylindrical, and a generally planar bottom surface 103. The ideal plane for slicing off the conical top 101 for gaining access to the water and endosperm inside is represented by the broken line 104. In order to access the tender meat and water of an immature coconut, the fruit is typically placed on a cutting board and the top portion thereof is whacked off with a sharp knife, generally just above the beginning of the cylindrical top portion. Though the procedure is relatively safe for those, such as butchers, who are skilled in the use of sharp knives, the procedure can be especially dangerous to the hands and fingers of those less skilled. In addition, as the fruit is at least initially lying on its side, spillage and loss of the coconut water is likely.

What is needed is a new method and apparatus for removing the top portion of an immature coconut that is safe, quick and easy and unlikely to result in spillage of the coconut water inside the fruit as the top portion thereof is removed.

### SUMMARY OF THE INVENTION

The present invention provides a method and apparatus for removing the top portion of an immature coconut with little, if any, spillage of the internal water. The apparatus includes an enclosure in which are housed a pair of opposed blades that are coupled by at least one rotatable shaft having both left-hand and right-hand threads. The inverse of a turnbuckle, opposite ends of each shaft engage an internally threaded sleeve affixed to each blade. When the rotatable shaft(s) is (are) axially rotated in a first direction, the blades are brought together in a cutting motion. The blades are positioned so that they both produce cuts in a generally common plane. When rotated in the opposite direction, the blades retract. For a preferred embodiment of the invention, each blade retracts beneath a blade guard that is rigidly attached to the enclosure. For a single shaft version of the apparatus, one end of each blade is pivotally coupled to the other. The rotatable shafts are preferably coupled together with gears, sprockets and a chain, toothed cogs and a toothed belt, or some equivalent arrangement so that a single input shaft can drive both shafts simultaneously at the same rotational speed. The rotatable shaft(s) can be rotated manually with a crank or wheel, or by an electric motor for added convenience. The enclosure also contains a clamping mechanism which secures the immature coconut at an optimum elevation and with its central axis generally vertical, so that the top portion of the fruit can be removed just below the upper limit of the hollow interior space so as to minimize spillage of the contained liquid. In order to facilitate both the elevational adjustment of the coconut during the clamping step and removal of the opened coconut, the enclosure also includes a coil spring, one end of which is attached to the bottom panel of the enclosure. When a coconut is placed within the enclosure, the unattached end of the spring contacts the coconut and, as the coconut is lowered into the enclosure, the coil spring is compressed. The use of the coil spring completely eliminates any need to turn the enclosure upside down in order to extract the coconut. If it were necessary to overturn the enclosure, all liquid internal to the coconut might be lost. The clamping mechanism is most easily constructed from a pair of rigid C-shaped half clamps, one end of each being pivotally coupled to the other. The opposite ends of the half clamps are coupled by a single axially-rotatable shaft having both left-handed and right-handed threads. In order to more completely ensure the safety of operation, the enclosure can be equipped with a cover and a blade safety release, so that the cover must be closed in order to move the blades. For a motor-powered version of the apparatus, the safety release can be a simple switch that is activated by lowering of the cover. For a mechanical version, various types of brakes or shaft locking devices can be installed that are released by a lowering of the cover.

A second embodiment cutting apparatus employs a pair of hinged blades and a cable actuation system to close the blades as a crank is turned in a clockwise direction, thereby pulling two cables simultaneously. The blades are spring loaded at the pivot joint, preferably with a single coil spring acting on both blades, so that they return to the full open position as the crank is turned in a counter-clockwise direction. The pulleys, crank and blade pivot are rigidly mounted to a cutting chamber. The round circle represents an immature coconut.

### BRIEF DESCRIPTION OF THE DRAWINGS

FIG. 1 is an elevational view of a husked immature coconut;

FIG. 2 is a top plan view of a the husked immature coconut of FIG. 1;

FIG. 3 is a bottom plan view of the husked immature coconut of FIG. 1;

FIG. 4 is a top plan view of an electric-motor-driven first embodiment cutting apparatus with its top cover removed;

FIG. 5 is a top plan view of the electric-motor-driven first embodiment cutting apparatus of FIG. 4, with the top cover in place;

FIG. 6 is a cross-sectional view through line 6-6 of FIG. 4;

FIG. 7 is a front elevational view of the electric-motor-driven first embodiment cutting apparatus, with the top cover removed;

FIG. 8 is a top plan view of the first embodiment cutting apparatus of FIG. 4, with a husked immature coconut clamped in place, and the blades in a retracted configuration;

FIG. 9 is a top plan view of the first embodiment cutting apparatus of FIG. 4, with a husked immature coconut clamped in place, and the top portion thereof severed by the blades, which are in a fully-closed configuration;

FIG. 10 is a top plan view of a crank-driven second embodiment cutting apparatus with its top cover removed;

FIG. 11 is a top plan view of the crank-driven second embodiment cutting apparatus of FIG. 10, with the top cover in place;

FIG. 12 is a cross-sectional view through line 12-12 of FIG. 10;

FIG. 13 shows a cable-operated third embodiment cutting apparatus in a full open position;

FIG. 14 shows the third embodiment cutting apparatus with the blades partially closed; and

FIG. 15 shows the third embodiment cutting apparatus with the blades fully closed.

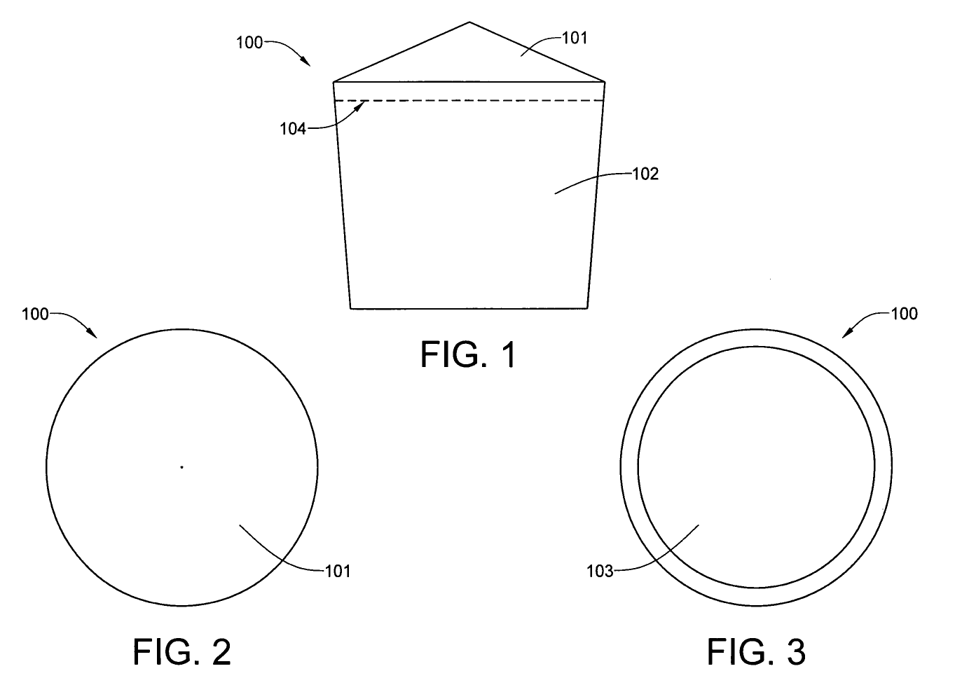

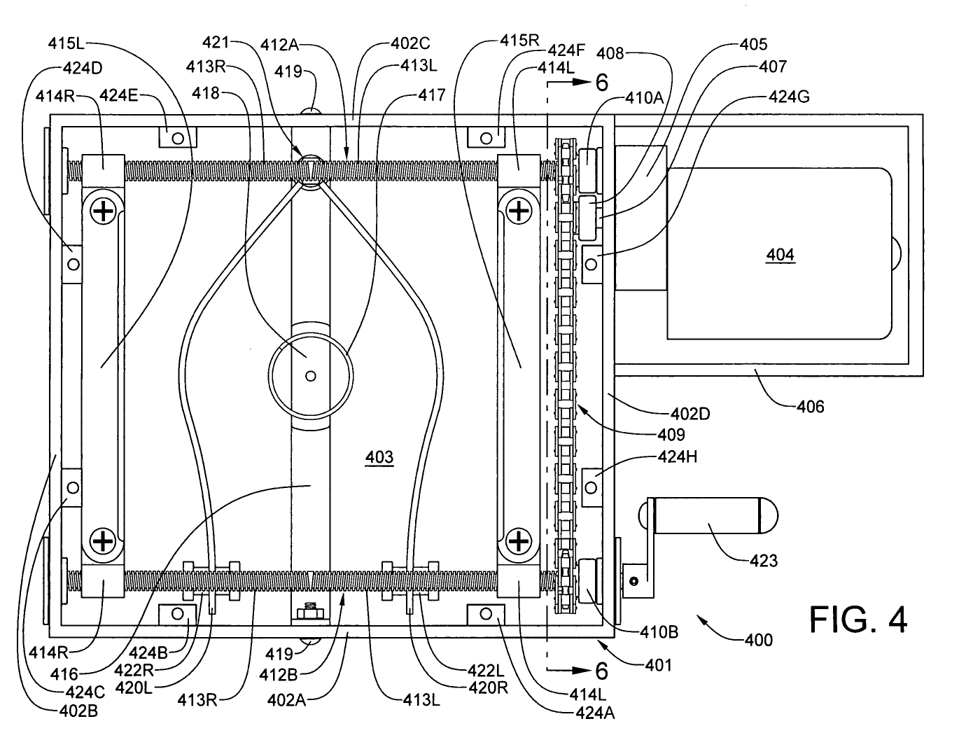

### DETAILED DESCRIPTION OF THE INVENTION

It should be understood that the apparatus shown and described herein is intended for use with immature coconuts which have been husked (i.e.,the mesocarp has been removed). Such coconuts have an endocarp that is fibrous and spongy—unlike the endocarp of mature coconuts, which is brittle and crackable.

The invention will now be described in detail with reference to the attached drawing figures.

Referring now to FIG. 4, an electric-motor-driven first embodiment cutting apparatus 400 has a generally rectangular cutting chamber 401 formed by four intersecting walls 402A, 402B, 402C, 402D and the base 403 of the enclosure. An electric motor 404 having a gearing module 405 for increased torque is enclosed in a motor housing 406. The motor 404 has an output shaft 407 to which a drive sprocket 408 is affixed. The item number 408 points to the mounting collar of the sprocket rather than the sprocket, itself, which is fairly well hidden by the drive chain 409, which engages the drive sprocket 408. The drive chain 409 also engages first and second output sprockets 410A and 410B, respectively, each of which is affixed to a rotatable blade drive shaft 412A and 412B, respectively. Each of the blade drive shafts 412A and 412B have a right-hand acme-threaded portion 413R and a left-hand acme-threaded portion 413L. A right-hand internal acme-threaded collar 414R rides on the right-hand acme-threaded portion 413 of each blade drive shaft 412A and 412B. Likewise, a left-hand internal acme-threaded collar 414L rides on the left-hand acme-threaded portion of each blade drive shaft 412A and 412B. A left blade 415L is attached with screws at opposite ends to each right-hand internal acme-threaded collar 414R, and a right blade 415R is attached with screws at opposite ends to each left-hand internal acme-threaded collar 414L. When the output shaft 407 is rotating in a clockwise direction (as viewed from inside the cutting chamber 401), the blades 415L and 415R move apart from one another. Conversely, when the output shaft 407 rotates in a counterclockwise direction, the blades 415L and 415R move toward one another. A bracket 416, a lower portion of which is in contact with the base 403, also has upwardly projection portions which is affixed to the walls 402A and 402C with threaded fasteners 419. The base coil of a stainless steel spring 417 is secured to the bracket 416 with a securing plate 418 and a central screw (shown, but not numbered). A stainless steel bolt 421, which acts as a pivot is also affixed to the bracket 416. A pair of arcuate half clamps 420L and 420R are each pivotally affixed at one end to the stainless steel bolt 421. There is a rotatable clamping shaft that is beneath the blade drive shaft 412B which also has right-hand and left-hand portions. As that clamping shaft is rotated by the crank 423, a pair of bobbin shaped followers 422R and 422L travel in opposite directions. When the crank 423 is turned in a first direction, the followers 422R and 422L move towards one another. When the crank 423 is turned in a second direction, the followers 422R and 422L move apart from one another. The non-pivotally attached end of each half clamp 420L and 420R has a slot. The slot of half clamp 420L captures follower 422R, while the slot of half clamp 420R captures follower 422L. Both bobbin-shaped followers have flattened central portions, which prevent them from rotating when the clamping shaft is rotated. As they are unable to rotate with the clamping shaft, they more the non-pivotally attached ends of the half clamps 420L and 420R together or apart, depending on the direction of rotation of the clamping shaft. Eight blade shield securing tabs 424A-424H, each of which has a threaded hole, are secured around the upper periphery of the cutting chamber 401.

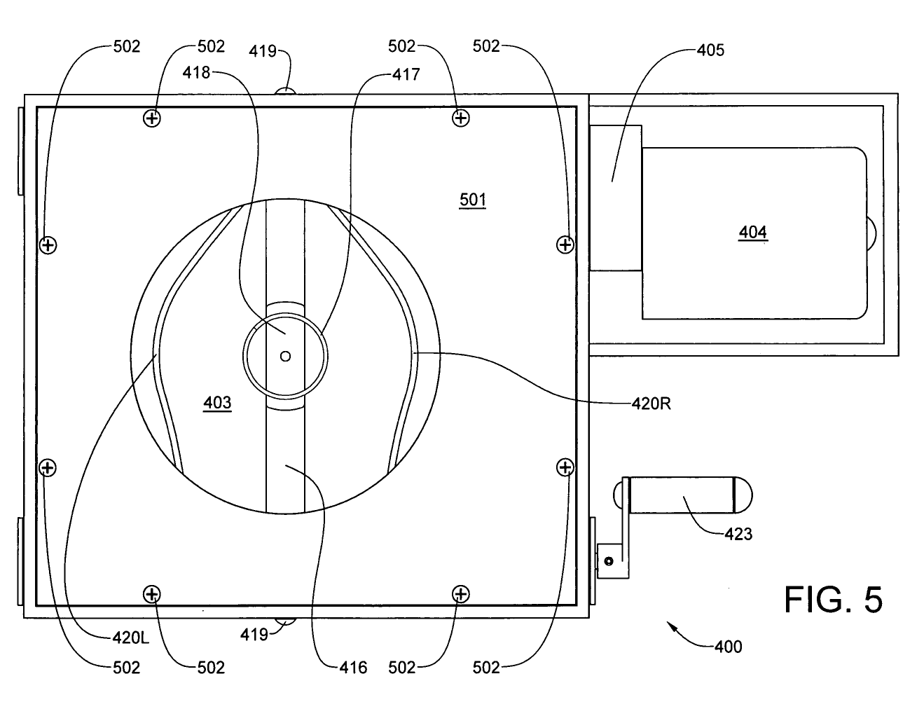

Referring now to FIG. 5, the blade shield 501 has been installed on the first embodiment cutting apparatus 400 using screws 502, which engage the threaded holes of the eight blade shield securing tabs 424A-424H.

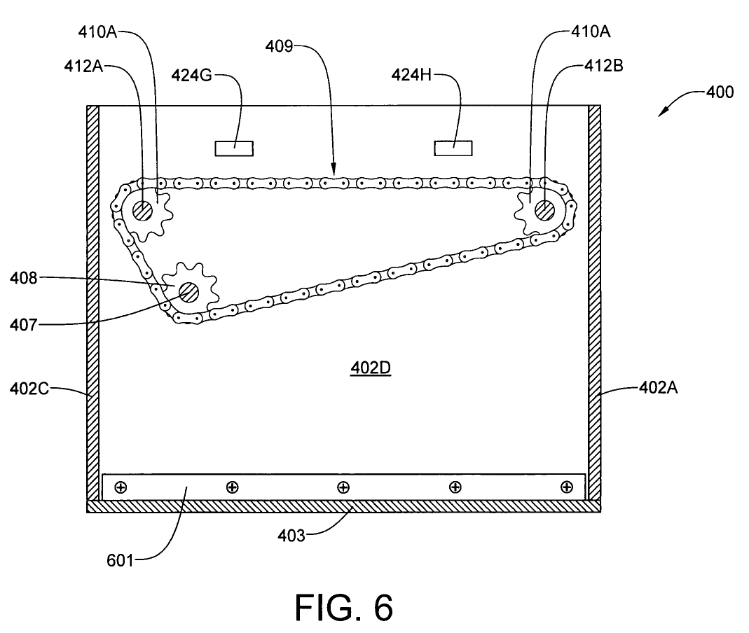

Referring now to FIG. 6, this cross sectional view shows the drive mechanism of the first embodiment cutting apparatus 400. The motor output shaft 407 is affixed to the drive sprocket 408. The drive sprocket 408 engages the chain 409. The chain wraps around first and second output sprockets 410A and 410B which are respectively affixed to blade drive shafts 412A and 412B. A hinge 601 permits the base 403 to be opened for cleaning.

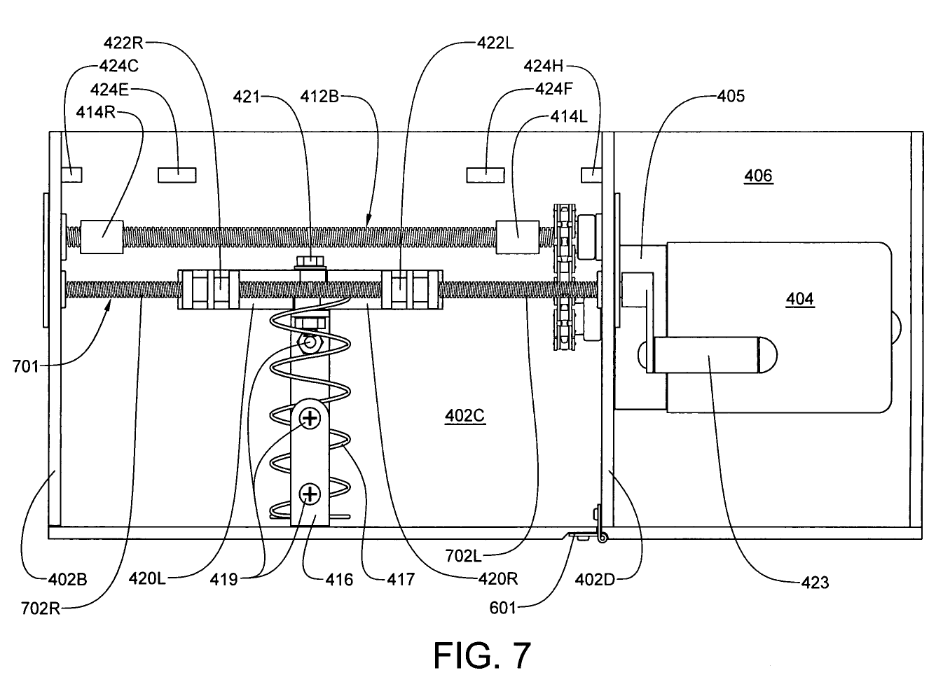

Referring now to FIG. 7, this front view shows the clamping shaft 701 and the bobbin-shaped followers 422R and 422L which ride on the clamping shaft 701. The clamping shaft 701 has a right-hand acme-threaded portion 702R and a left-hand acme-threaded portion 702L. The coil spring 417 is used to assist in positioning an immature coconut while rotating the crank 423 to secure the coconut between the half clamps 420L and 420R.

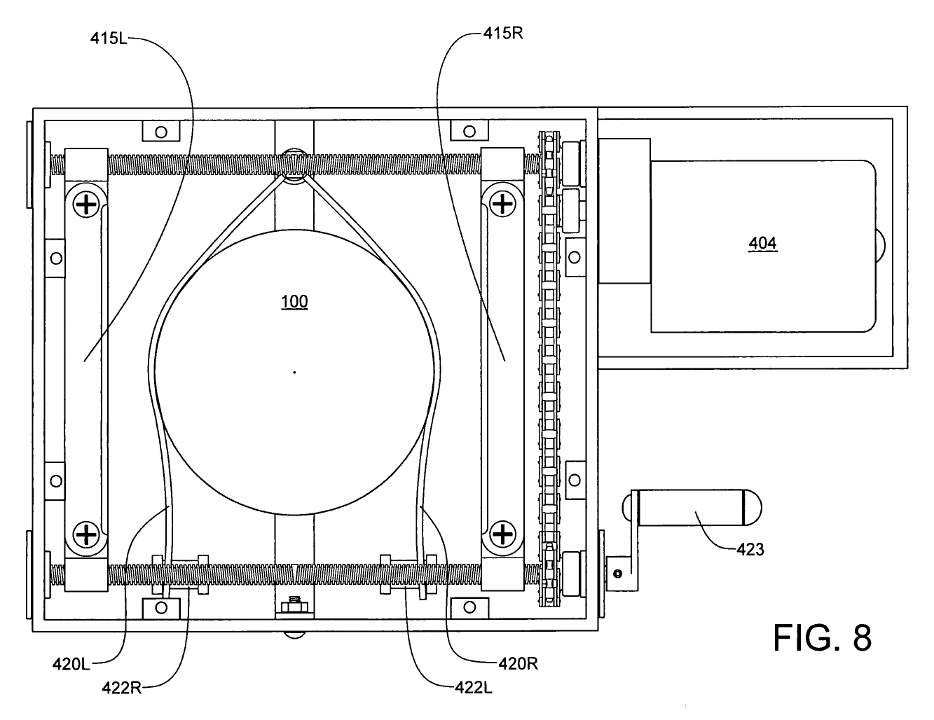

Referring now to FIG. 8, an immature coconut 100 has been secured within the first embodiment cutting apparatus 400 between the half clamps 420L and 420R by rotating the crank 423. The blade shield 501 has been removed to better show the functioning of the various components. It will be noted that, as the motor has not yet been powered on, the blades 415L and 415R are positioned nearly a maximum distance apart.

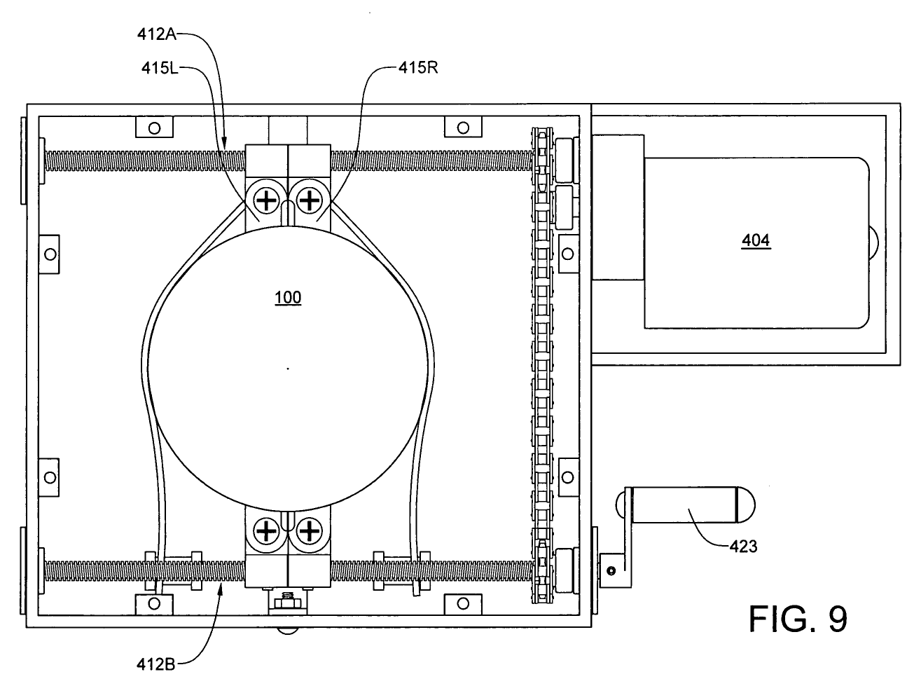

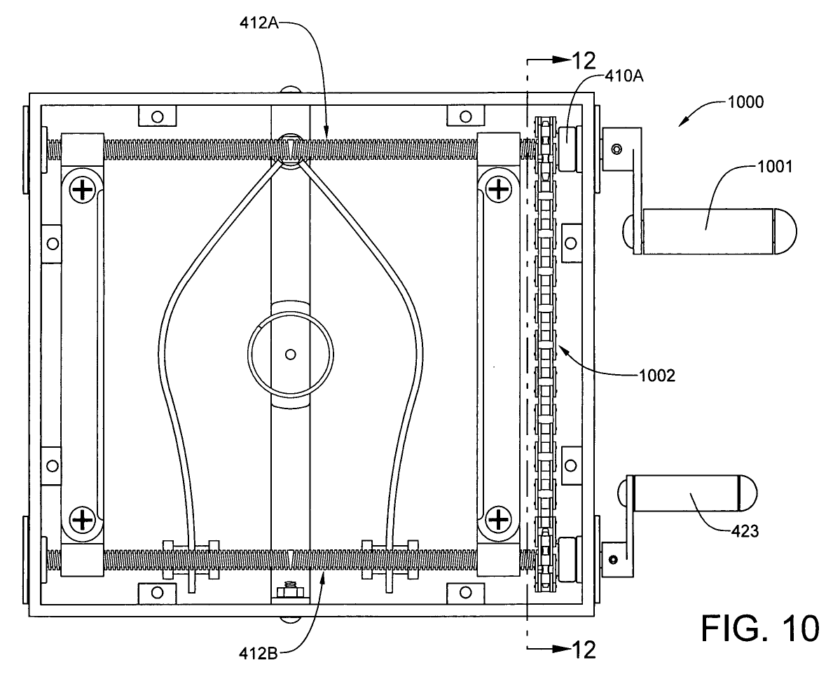

Referring now to FIG. 9, the electric motor 404 has been powered on such that it rotated in a counterclockwise direction, thereby moving the blades 415L and 415R together so that the conical top of the coconut is severed from the lower almost cylindrical lower portion 102. After the top is severed, the blades are retracted by operating the motor in a clockwise direction. The coconut is then released from the half clamps 420L and 420R by rotating the crank 423 in a counterclockwise direction (as seen from outside the cutting chamber 401).

Referring now to FIG. 10, a crank-operated second embodiment cutting apparatus 1000 is very similar to the first embodiment cutting apparatus 400, with the exception that the electric motor 404 has been replaced with a second hand-operated crank 1001, which operates directly on the first blade drive shaft 412A. The first and second output sprockets 410A and 410B are coupled directly by the chain 1002.

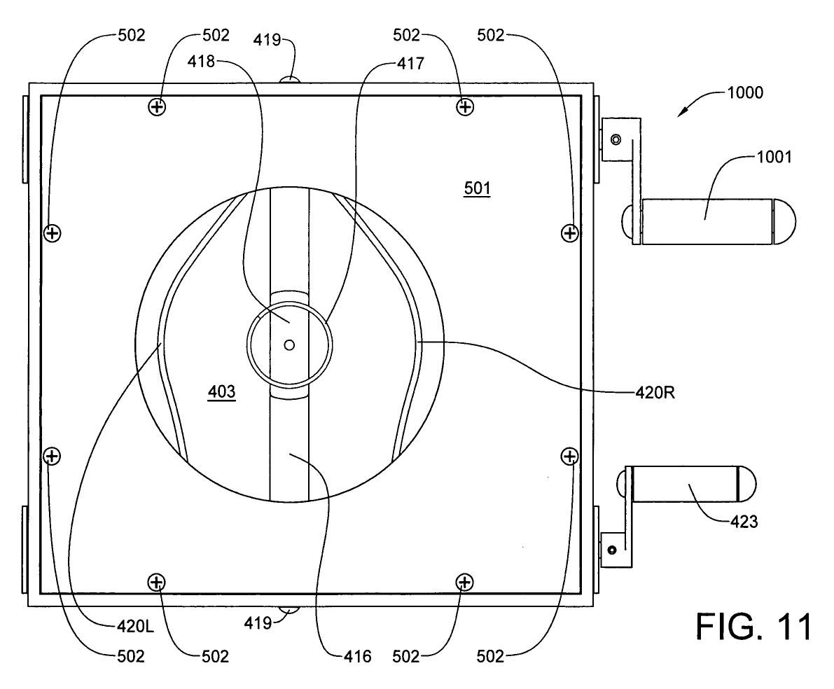

Referring now to FIG. 11, the blade shield 501 has been installed on the second embodiment cutting apparatus 1000 using screws 502, which engage the threaded holes of the eight blade shield securing tabs 424A-424H.

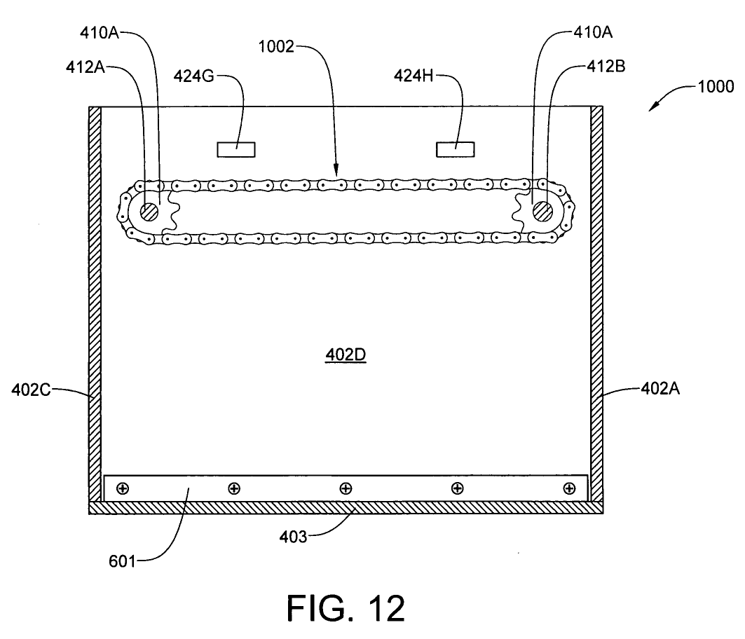

Referring now to FIG. 12, this cross sectional view shows the drive mechanism of the first embodiment cutting apparatus 1000. The chain wraps around first and second output sprockets 410A and 410B which are respectively affixed to blade drive shafts 412A and 412B. The second hand-operated crank 1001 (not visible in this view), operates directly on the first blade drive shaft 412A. A hinge 601 permits the base 403 to be opened for cleaning.

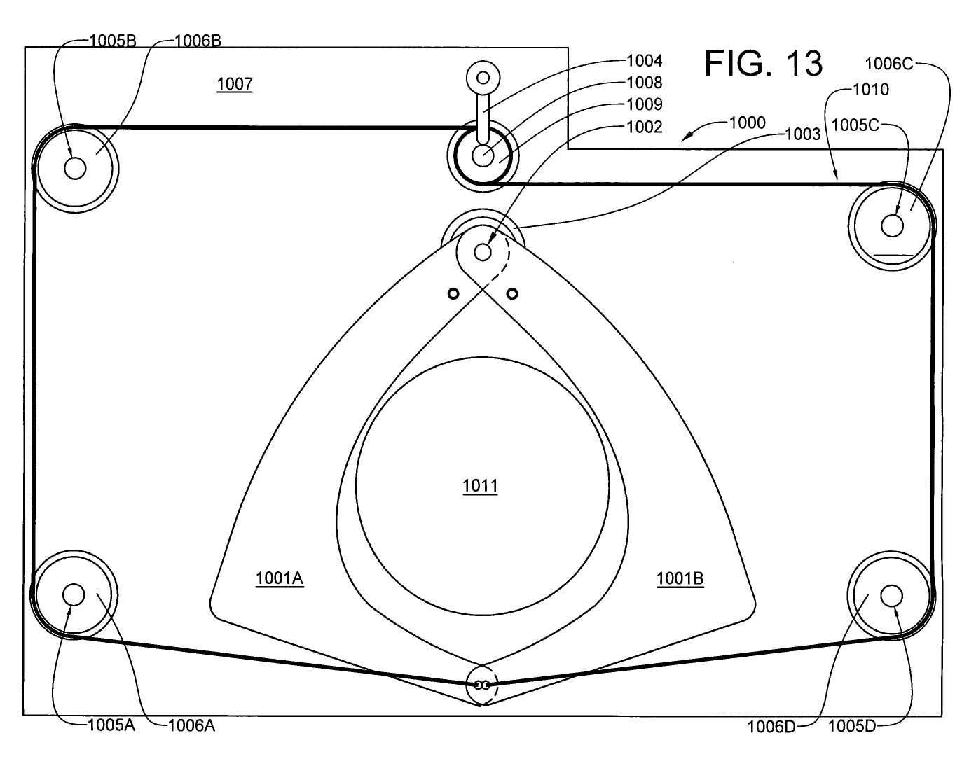

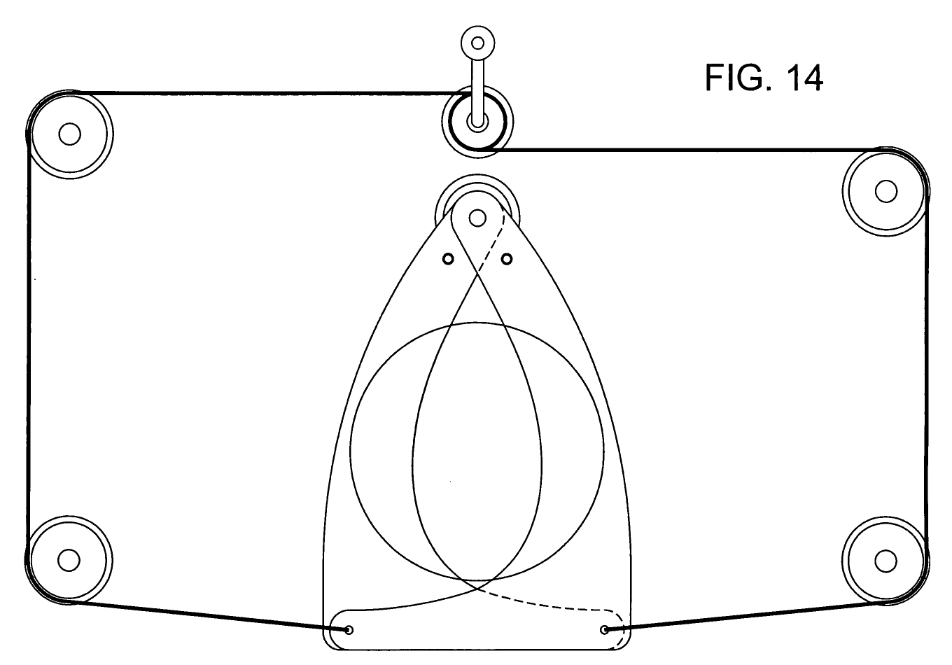

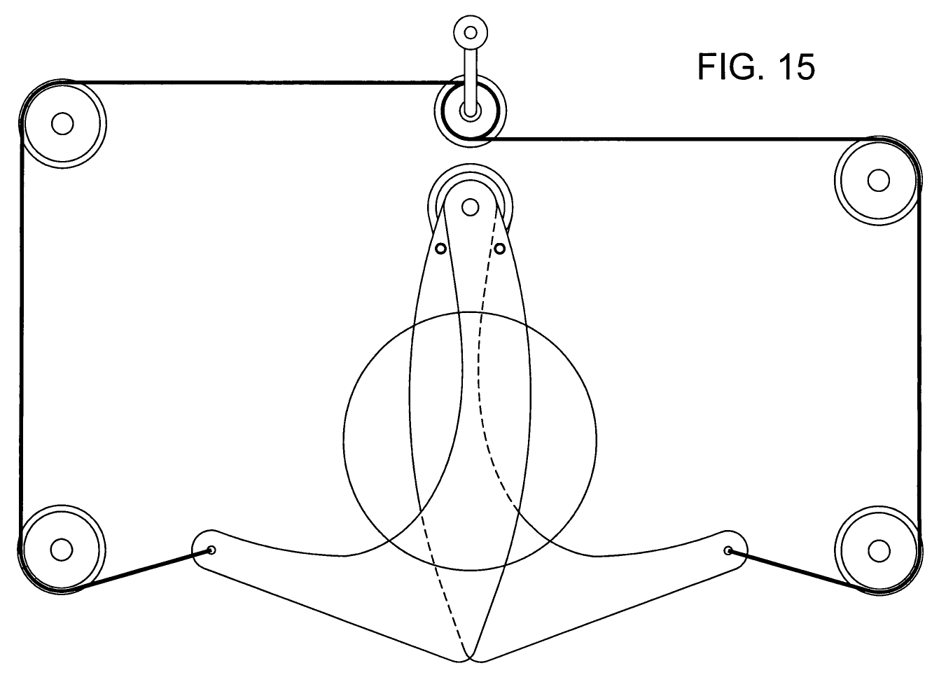

Referring now to FIGS. 13, 14 and 15, a second embodiment cutting apparatus 1000 employs a pair of hinged blades 1301A and 1301 B and a cable actuation system to close the blades. The blades are spring loaded at a hinge joint 1302, preferably with a single coil spring 1303 acting on both blades, so that they return to the full open position of FIG. 13 as the crank 1304 is turned in a counter-clockwise direction. The vertical axles 1305A, 1305B, 1305C, and 1305D on which directional change pulleys 1306A, 1306B, 1306C, and 1306D, respectively, are rotationally mounted, are rigidly affixed to the base 1307 of a cutting chamber (not shown), as is the vertical axle 1308 on which the winch pulley 1309 is mounted. The crank 1304 is rigidly affixed to the winch pulley 1309. The cable 1310 wraps around the pulleys 1306A, 1306B, 1306C and 1306D and is secured to winch pulley 1309. The circle 1311 represents an immature coconut.

Although only several embodiments of the invention have been disclosed herein, it will be obvious to those having ordinary skill in the art that changes and modifications may be made thereto without departing from the spirit and scope of the invention as hereinafter claimed.

What is claimed is:

1. An apparatus for removing the top portion of an immature coconut having a hollow interior space at least partially filled with liquid with minimal loss of the liquid, said apparatus comprising:
an enclosure;
a pair of opposed blades which cut in a generally common plane;
at least one threaded sleeve pair, each sleeve of each pair being attached to an end of each blade;
wherein the threaded sleeves of each threaded sleeve pair are axially aligned with one another; and
wherein the threaded sleeves of each axially-aligned sleeve pair have opposite-hand threading;
at least one rotatable blade adjustment shaft, half of which is equipped with right-hand threads, the other half being equipped with left-hand threads, said at least one rotatable blade adjustment shaft engaging a pair of axially-aligned sleeve pair;
means for axially rotating said at least one rotatable blade-adjustment shaft in a first direction so as to draw said pair of opposed blades together in a cutting configuration and in a second direction so as to move said blades apart to a retracted configuration;
a clamping mechanism for securing an immature coconut with its central axis generally perpendicular at an optimum elevation so that a top portion of the coconut can be removed just below the upper limit of the hollow interior space.

2. The apparatus of claim 1, which further comprises a vertically-compressible coil spring, positioned placed below the clamping mechanism, which facilitates removal of a coconut from which the top portion has been removed.

3. The apparatus of claim 1, which further comprises a pair of blade guards rigidly attached to said enclosure on opposite sides thereof, each blade guard being associated with a single blade and covering the associated blade after it retracts from said cutting configuration.

4. The apparatus of claim 1, wherein for an embodiment having dual rotatable blade adjustment shafts, both blade adjustment shafts are coupled together with a slipless, indexed drive system, so that a single power input shaft can drive both shafts simultaneously at the same rotational speed.

5. The apparatus of claim 1, wherein said at least one rotatable shaft is rotated manually.

6. The apparatus of claim 1, wherein said at least one rotatable shaft is rotated with an electric motor.

7. The apparatus of claim 6, wherein at least one first-direction limit switch is used to cut off power to the electric motor when the blades are drawn together and the cutting edges are almost in contact with one another, and at least one second-direction limit switch is used to cut off power to the electric motor as the blades approach the retracted configuration.

8. The apparatus of claim 1, wherein said clamping mechanism comprises:
first and second arcuate half-clamps, the concave side of each half-clamp facing the other, an end of each arcuate half-clamp pivotally affixed to a generally vertical stationary anchor post affixed to said enclosure;
first and second threaded collars, said first collar having internal threads which are opposite-handed from those of the second collar, said first threaded collar being coupled to a non-pivotally-affixed end of said first arcuate half-clamp and said second threaded collar being coupled to a non-pivotally-affixed end of said second arcuate half-clamp;
a horizontally disposed rotatable threaded clamping shaft, each half of the rotatable threaded clamping shaft engaging one of said threaded collars, such that when said clamping shaft is axially rotated in a first direction, said first and second arcuate half-clamps are brought together in a clamping configuration, and when axially rotated in the opposite second direction, said first and second arcuate half-clamps are pulled apart so as to release a secured coconut.

9. The apparatus of claim 1, which further comprises:
a hingeable cover which provides access to interior of the enclosure; and
a safety latch, which precludes opening the hingeable cover unless the blades are in their retracted configuration.

10. An apparatus for removing the top portion of an immature coconut having a hollow interior space at least partially filled with liquid with minimal loss of the liquid, said apparatus comprising:
an enclosure;
a pair of opposed laminar blades having generally straight cutting edges, both blades oriented to cut in a generally common plane;
first and second threaded sleeve pairs, each sleeve of each pair being attached to an end each blade;
wherein the threaded sleeves of each threaded sleeve pair are axially aligned with one another; and
wherein the threaded sleeves of each axially-aligned sleeve pair have opposite-hand threading;
first and second rotatable blade adjustment shafts, a first half of each shaft being equipped with right-hand threads, the second half being equipped with left-hand threads, said first rotatable blade adjustment shaft engaging said first threaded sleeve pair, and said second rotatable blade adjustment shaft engaging said second threaded sleeve pair;
means for axially rotating said first rotatable blade-adjustment shaft in a first direction and said second rotatable blade-adjustment shaft in a second direction so as to draw said pair of opposed blades together in a cutting configuration and said first rotatable blade-adjustment shaft in a third direction and said second rotatable blade-adjustment shaft in a fourth direction so as to move said blades apart to a retracted configuration;
a clamping mechanism for securing an immature coconut with its central axis generally perpendicular at an optimum elevation so that a top portion of the coconut can be removed just below the upper limit of the hollow interior space.

11. The apparatus of claim 10, wherein said first and second directions are the same rotational direction, and said third and fourth directions are the same rotational direction.

12. The apparatus of claim 10, which further comprises a vertically-compressible coil spring, positioned placed below the clamping mechanism, which facilitates removal of a coconut from which the top portion has been removed.

13. The apparatus of claim 10, which further comprises a pair of blade guards rigidly attached to said enclosure on opposite sides thereof, each blade guard being associated with a single blade and covering the associated blade after it retracts from said cutting configuration.

14. The apparatus of claim 10, wherein said first and second blade adjustment shafts are coupled together with a slipless, indexed drive system, so that a single power input shaft can drive both shafts simultaneously at the same rotational speed.

15. The apparatus of claim 14, wherein either said first and second blade adjustment shafts has a hand crank attached to an end thereof so that both first and second blade adjustment shafts can be rotated manually in either direction.

16. The apparatus of claim 14, wherein said slipless, indexed drive system is coupled to an electric motor.

17. The apparatus of claim 16, wherein at least one first-direction limit switch is used to cut off power to the electric motor when the blades are drawn together and the cutting edges are almost in contact with one another, and at least one second-direction limit switch is used to cut off power to the electric motor as the blades approach the retracted configuration.

18. The apparatus of claim 16, wherein said clamping mechanism comprises:
first and second arcuate half-clamps, the concave side of each half-clamp facing the other, an end of each arcuate half-clamp pivotally affixed to a generally vertical stationary anchor post affixed to said enclosure;
first and second threaded collars, said first collar having internal threads which are opposite-handed from those of the second collar, said first threaded collar being coupled to a non-pivotally-affixed end of said first arcuate half-clamp and said second threaded collar being coupled to a non-pivotally-affixed end of said second arcuate half-clamp;
a horizontally disposed rotatable threaded clamping shaft, each half of the rotatable threaded clamping shaft engaging one of said threaded collars, such that when said clamping shaft is axially rotated in a first direction, said first and second arcuate half-clamps are brought together in a clamping configuration, and when axially rotated in the opposite second direction, said first and second arcuate half-clamps are pulled apart so as to release a secured coconut.

19. The apparatus of claim 10, which further comprises:
a hingeable cover which provides access to interior of the enclosure; and
a safety latch, which precludes opening the hingeable cover unless the blades are in their retracted configuration.

20. The apparatus of claim 18, wherein said rotatable clamping shaft is coupled to the electric motor via a torque-limited clutch.
